(19) United States
(12) Patent Application Publication
(10) Pub. No.: US 2026/0347229 A1
(43) Pub. Date: Nov. 5, 2026

(54) APPARATUS AND METHOD FOR COOLING MOLTEN GLASS IN A CONDUIT

(71) Applicant: Corning Incorporated, Corning, NY (US)

(72) Inventors: Michael Bruce Cain, Leland, NC (US); Aaron Joshua Hade, Corning, NY (US); Timothy Joseph Helmers, Danville, KY (US); Matthew Brian Kubilius, Horseheads, NY (US); Irene Mona Peterson, Elmira Heights, NY (US); Douglas Benjamin Rapp, Danville, KY (US); Steven Robert Wagner, Corning, NY (US)

(21) Appl. No.: 19/117,666

(22) PCT Filed: Oct. 2, 2023
(86) PCT No.: PCT/US2023/034250

§ 371 Date: Apr. 2, 2025

Related U.S. Application Data
(60) Provisional application No. 63/378,310, filed on Oct. 4, 2022.

(51) Int. Cl. C03B 7/06

(52) U.S. Cl. CPC C03B 7/06

(57) ABSTRACT

A conduit configured to convey molten glass from one molten glass processing vessel to another molten glass processing vessel, the conduit comprising a cooling tube extending through the conduit and configured to receive a flow of cooling fluid therethrough, thereby cooling molten glass flowing through the conduit.

### CROSS-REFERENCE TO RELATED APPLICATIONS

This application claims the benefit of priority under 35 U.S.C. § 119 of U.S. Provisional Application Ser. No. 63/378,310 filed on Oct. 4, 2022, the content of which is relied upon and incorporated herein by reference in its entirety.

### FIELD

The present disclosure relates to a heat extraction apparatus, and more particularly, a conduit for extracting heat from molten glass flowing therethrough.

### BACKGROUND

The manufacture of glass articles, for example glass sheets, generally involves the conveyance of molten glass from a melting furnace, through multiple processing vessels, to a forming apparatus that forms the molten glass into the desired glass article. Between the melting furnace and the forming apparatus the temperature of the molten glass must be closely regulated to achieve a temperature (e.g., viscosity) suitable for forming. Cooling of the molten glass is typically achieved within conduits extending between the various processing vessels via radiative cooling. Increasing the flow of molten glass, for example to increase production output, generally requires an increase in heat loss from the conduits to achieve the requisite forming temperature. This may be achieved by extending the length or diameter of the conduits, thereby increasing surface area, using higher thermal conductivity refractory materials, or increasing forced convection cooling applied to an exterior of the refractory materials. However, there is a limit to the effectiveness of these approaches. Moreover, these cooling methods necessarily extract heat from the outside of the conduit inward, which can develop a large radial temperature—and therefore viscosity—gradient in the flow of molten glass.

### SUMMARY

In a first aspect, a glass manufacturing apparatus is disclosed, comprising a first molten glass processing vessel, a second molten glass processing vessel, and a conduit extending between the first molten glass processing vessel and the second molten glass processing vessel, the conduit defining an interior passage extending therethrough configured to convey molten glass between the first molten glass processing vessel and the second molten glass processing vessel, the conduit comprising a cooling tube extending through the interior passage of the conduit, the at least one cooling tube defining a cooling passage isolated from the interior passage of the conduit by a wall of the cooling tube.

In a second aspect, the cooling tube of the glass manufacturing apparatus of the first aspect may comprise a ceramic refractory lining arranged within the cooling passage.

In a third aspect, the wall of the cooling tube of the glass manufacturing apparatus of the first or second aspect may comprise platinum.

In a fourth aspect, the wall of the cooling tube of the glass manufacturing apparatus of the third aspect comprises a platinum-rhodium alloy.

In a fifth aspect, the conduit of the glass manufacturing apparatus of any of the first through the fourth aspects may be surrounded by a ceramic refractory material, the cooling tube extending outward from the conduit through the ceramic refractory material.

In a sixth aspect, the conduit and the ceramic refractory material of the glass manufacturing apparatus of the fifth aspect may be arranged in an enclosure and ends of the cooling tube may be open to an atmosphere in the enclosure.

In a seventh aspect, The glass manufacturing apparatus of claim 5, the conduit and the ceramic refractory material of the glass manufacturing apparatus of the fifth aspect may be arranged in an enclosure and the cooling tube may extend through the ceramic refractory material and a wall of the enclosure.

In an eighth aspect, The glass manufacturing apparatus of any one of claims 1 to 7, the conduit of the glass manufacturing apparatus of any one of the first through the seventh aspects may comprise a central longitudinal axis, wherein a longitudinal axis of the cooling tube may extend orthogonal to the longitudinal axis of the conduit.

In a ninth aspect, the cooling tube of the glass manufacturing apparatus of the first aspect may comprise a plurality of cooling tubes.

In a tenth aspect, The glass manufacturing apparatus of claim 9, the plurality of cooling tubes of the glass manufacturing apparatus of the ninth aspect may be spaced apart and arranged linearly along a longitudinal axis of the conduit.

In an eleventh aspect, the first molten glass processing vessel of the glass manufacturing apparatus of any one of the first through the tenth second aspects may comprise a fining vessel and the second molten glass processing vessel comprises a mixing apparatus.

In a twelfth aspect, the first molten glass processing vessel of the glass manufacturing apparatus of any one of the first through the ninth aspects may comprise a mixing apparatus and the second molten glass processing vessel may comprise a delivery vessel including an exit conduit extending from a bottom of the delivery vessel.

In a thirteenth aspect, The glass manufacturing apparatus of claim 1, the cooling tube of the glass manufacturing apparatus of the first aspect may comprise a cooling chamber positioned within the conduit, the cooling chamber comprising a plurality of pass-through passages defined by interior surfaces of a plurality of cross-tubes extending through the cooling chamber, the flow-through passages configured to allow at least a portion of the molten glass conveyed through the conduit to flow through the flow-through passages.

In a fourteenth aspect, exterior surfaces of the plurality of cross-tubes of the glass manufacturing apparatus of the thirteenth aspect may be coated with a refractory ceramic material.

In a fifteenth aspect, a method of manufacturing a molten glass article is described, comprising flowing molten glass from a first molten glass processing vessel to a second molten glass processing vessel through an interior passage defined by a conduit extending between the first molten glass processing vessel and the second molten glass processing vessel, and cooling the molten glass in the conduit by flowing a cooling fluid through a cooling passage of a cooling tube extending through the interior passage.

In a sixteenth aspect, the cooling fluid of the method of the fifteenth aspect may comprise an inert gas.

In a seventeenth aspect, the method of the fifteenth or the sixteenth aspect may further comprise cooling the cooling fluid prior to flowing the cooling fluid through the cooling passage.

In an eighteenth aspect, the cooling tube of the method of any one of the fifteenth through the seventeenth aspects may comprise a refractory ceramic lining arranged within the cooling passage.

In a nineteenth aspect, the cooling tube of any one of the fifteenth aspect through the eighteenth aspect may comprise a cooling chamber positioned within the conduit, the cooling chamber comprising a plurality of cross tubes extending through the cooling chamber, interior surfaces of the plurality of cross-tubes defining flow-through passages, the method further comprising flowing at least a portion of the molten glass flowing through the interior passage of the conduit through the flow-through passages.

In a twentieth aspect, the cooling tube of the method of any one of the fifteenth through the eighteenth aspects may comprise a plurality of cooling tubes.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

FIG. 1 is a schematic view of an exemplary glass manufacturing apparatus comprising a plurality of molten glass processing vessels connected by conduits;

FIG. 2A is a perspective view of an exemplary conduit from FIG. 1 comprising at least one cooling tube extending through an interior passage of the conduit;

FIG. 2B is a cross-sectional end view of the conduit of FIG. 2A;

FIG. 3 is a cross-sectional view of the at least one cooling tube showing the refractory lining;

FIG. 4 is a perspective view of an exemplary conduit of FIG. 1 comprising at least one cooling tube extending horizontally across an interior passage of the conduit;

FIG. 5 is a perspective view of an exemplary conduit from FIG. 1 comprising at least one cooling tube extending along a longitudinal axis of the conduit for at least a portion of a length of the conduit;

FIG. 6 is a cross-sectional view of the conduit of FIG. 2A, the conduit surrounded by a ceramic refractory material, the conduit and the ceramic refractory material enclosed in an enclosure, and the at least one cooling tube extending from the conduit through the ceramic refractory material and in fluid communication with a jacket volume enclosed by the enclosure;

FIG. 7 is a cross-sectional view of the conduit of FIG. 2A, the conduit surrounded by a ceramic refractory material, the conduit and the ceramic refractory material enclosed in an enclosure, and the at least one cooling tube extending from the conduit through the ceramic refractory material and the enclosure, the cooling tube supplied with a cooling fluid from a source outside the enclosure;

FIG. 8 is a perspective view, at least partially transparent, showing a cooling tube comprising a cooling chamber positioned within an interior of the conduit, the cooling chamber comprising a plurality of flow-through passages through which molten glass may flow, the flow-through passages extending through the cooling chamber and defined by a plurality of cross-tubes, the molten glass isolated from the cooling fluid flowing in the cooling chamber by walls of the cross-tubes;

FIG. 9 is a cross-sectional view of the conduit of FIG. 7 showing the flow of cooling fluid in the cooling chamber;

FIG. 10 is a graph of modeled normalized temperature as a function of position across a width of a conduit carrying molten glass illustrating a reduced radial thermal gradient in a conduit with an internal cooling tube after adjustment for flow and power compared to a base case without internal cooling; and

FIG. 11 is a graph of modeled normalized temperature as a function of position along a length of the conduit of FIG. 7, at various points along a periphery of the conduit illustrating a reduced radial thermal gradient in a conduit with an internal cooling tube after adjustment for flow and power compared to a base case without internal cooling.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure can be embodied in many different forms and should not be construed as limited to the embodiments set forth herein.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Ranges can be expressed herein as from “about” one particular value, and/or to “about” another particular value. When such a range is expressed, another embodiment includes from the one particular value to the other particular value. Similarly, when values are expressed as approximations by use of the antecedent “about,” it will be understood that the particular value forms another embodiment. It will be further understood that the endpoints of each of the ranges are significant both in relation to the other endpoint, and independently of the other endpoint.

Directional terms as used herein—for example, up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including matters of logic with respect to arrangement of steps, operational flow, order of components, or orientation of components; plain meaning derived from grammatical organization or punctuation, and; the number or type of embodiments described in the specification.

As used herein, the singular forms “a,” “an,” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including,” and variations thereof, shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

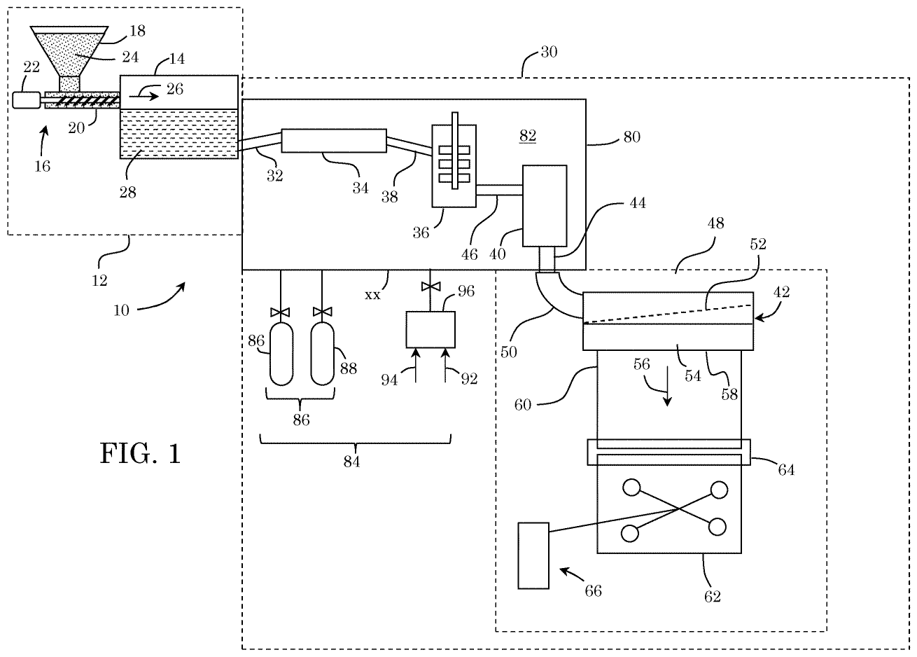

Shown in FIG. 1 is an exemplary glass manufacturing apparatus 10. Glass manufacturing apparatus 10 comprises a glass melting furnace 12 including a melting vessel 14. In addition to melting vessel 14, glass melting furnace 12 may optionally include one or more additional components such as heating elements (e.g., combustion burners and/or electrodes) configured to heat raw material and convert the raw material into a molten material, hereinafter, molten glass. For example, melting vessel 14 may be an electrically boosted melting vessel, wherein energy is added to the raw material through both combustion burners and by direct heating, wherein an electrical current is passed through the raw material, the electrical current adding energy via Joule heating of the raw material.

Glass melting furnace 12 may include other thermal management devices (e.g., thermal insulation components) that reduce heat loss from the melting vessel. Glass melting furnace 12 may include electronic and/or electromechanical devices that facilitate melting of the raw material into molten glass. Glass melting furnace 12 may include support structures (e.g., support chassis, support member, etc.) or other components not shown in FIG. 1.

Melting vessel 14 may be formed from a refractory material, for example a refractory ceramic material comprising alumina or zirconia, although the refractory ceramic material can comprise other refractory materials, such as yttrium (e.g., yttria, yttria-stabilized zirconia, yttrium phosphate), zircon (ZrSiO₄) or alumina-zirconia-silica or even chrome oxide, used either alternatively or in any combination. In some examples, melting vessel 14 may be constructed from refractory ceramic bricks.

Glass melting furnace 12 may be incorporated as a component of glass manufacturing apparatus 10 configured to fabricate a glass article, for example a glass ribbon, although in further embodiments, the glass melting furnace may be incorporated into a glass manufacturing apparatus configured to form other glass articles without limitation, such as glass rods, glass tubes, glass envelopes (for example, glass envelopes for lighting devices, e.g., light bulbs), glass containers, and glass lenses. In some examples, glass melting furnace 12 may be included in a glass manufacturing apparatus comprising a slot draw apparatus, a float bath apparatus, a down-draw apparatus (e.g., a fusion down-draw apparatus), an up-draw apparatus, a pressing apparatus, a rolling apparatus, a tube drawing apparatus, or any other glass manufacturing apparatus that would benefit from the present disclosure. By way of example, FIG. 1 schematically illustrates glass melting furnace 12 as a component of a fusion down-draw glass manufacturing apparatus for fusion drawing a glass ribbon for subsequent processing into individual glass sheets or rolling the glass ribbon onto a spool for later use. As used herein, fusion drawing comprises flowing molten glass over inclined, e.g., converging, side surfaces of a forming body, wherein the resulting streams of molten material join, or “fuse,” at the bottom of the forming body to form a glass ribbon.

Glass manufacturing apparatus 10 may optionally include an upstream glass manufacturing apparatus 16 positioned upstream of melting vessel 14. In some examples, a portion of, or the entire upstream glass manufacturing apparatus 16, can be incorporated as part of the glass melting furnace 12.

As shown in FIG. 1, upstream glass manufacturing apparatus 16 may include a raw material storage bin 18, a raw material delivery device 20, and a motor 22 connected to raw material delivery device 20. Raw material storage bin 18 may be configured to store raw material 24 that can be fed into melting vessel 14 through one or more feed ports, as indicated by arrow 26. Raw material 24 typically comprises at least one or more glass forming metal oxides and one or more modifying agents. In some examples, raw material delivery device 20 may be powered by motor 22 to deliver a predetermined amount of raw material 24 from raw material storage bin 18 to melting vessel 14. In further examples, motor 22 may power raw material delivery device 20 to introduce raw material 24 at a controlled rate based on a level of molten glass sensed downstream from melting vessel 14 relative to a flow direction of the molten glass. Raw material 24 within melting vessel 14 can thereafter be heated to form molten glass 28. Typically, the raw material is added to the melting vessel as particulate, for example as various “sands.” Raw material 24 may also include scrap glass (i.e., cullet) from previous melting and/or forming operations. Combustion burners may be used to begin the melting process. In an electrically boosted melting process, once the electrical resistance of the raw material is sufficiently reduced by the combustion burners, electric boost can begin by developing an electrical potential between electrodes positioned in contact with the raw material, thereby establishing an electrical current through the raw material, the raw material typically entering, or in, a molten state.

Glass manufacturing apparatus 10 may also include a downstream glass manufacturing apparatus 30 positioned downstream of glass melting furnace 12 relative to a flow direction of molten glass 28. In some examples, a portion of downstream glass manufacturing apparatus 30 may be incorporated as part of glass melting furnace 12. For instance, first connecting conduit 32 discussed below, or other portions of the downstream glass manufacturing apparatus 30, may be incorporated as part of the glass melting furnace 12.

Downstream glass manufacturing apparatus 30 may include a first conditioning chamber, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. Accordingly, first connecting conduit 32 provides a flow path for molten glass 28 from melting vessel 14 to fining vessel 34. However, other conditioning chambers may be positioned downstream of melting vessel 14, for example between melting vessel 14 and fining vessel 34. In some embodiments, a conditioning chamber may be employed between the melting vessel and the fining chamber. For example, molten glass from a primary melting vessel can be further heated in a secondary melting (conditioning) vessel or cooled in the secondary melting vessel to a temperature lower than the temperature of the molten glass in the primary melting vessel before entering the fining chamber.

Bubbles may be removed from molten glass 28 by various techniques. For example, raw material 24 may include multivalent compounds (i.e., fining agents) such as tin oxide that, when heated, undergo a chemical reduction reaction and release oxygen. Other suitable fining agents can include without limitation arsenic, antimony, iron, and/or cerium, although the use of arsenic and antimony, owing to their toxicity, may be discouraged in some applications for environmental reasons. Fining vessel 34 is heated, for example to a temperature greater than the melting vessel interior temperature, thereby heating the fining agent to a sufficient reaction temperature for chemical reduction. Oxygen produced by the temperature-induced chemical reduction of one or more fining agents included in the molten glass can be included with gas bubbles produced during the melting process. The enlarged gas bubbles with increased buoyancy then rise to a free surface of the molten glass within the fining vessel and are thereafter vented from the fining vessel, for example through a vent tube in fluid communication with the atmosphere above the free surface.

Downstream glass manufacturing apparatus 30 may further include another conditioning chamber, such as mixing apparatus 36, for example a stirring vessel, for mixing the molten glass that flows downstream from fining vessel 34. Mixing apparatus 36 can be used to provide a homogenous glass melt composition, thereby reducing chemical and/or thermal inhomogeneities that may otherwise exist within the molten glass exiting the fining vessel. As shown, fining vessel 34 may be coupled to mixing apparatus 36 by way of a second connecting conduit 38. Accordingly, molten glass 28 can be gravity fed from the fining vessel 34 to mixing apparatus 36 through second connecting conduit 38. Typically, the molten glass within mixing apparatus 36 includes a free surface, with a free (e.g., gaseous) volume extending between the free surface and a top of the mixing apparatus. While mixing apparatus 36 is shown downstream of fining vessel 34 relative to a flow direction of molten glass 28, mixing apparatus 36 may be positioned upstream from fining vessel 34 in other embodiments. Downstream glass manufacturing apparatus 30 may include multiple mixing apparatus, for example a mixing apparatus upstream from fining vessel 34 and a mixing apparatus downstream from fining vessel 34. When used, multiple mixing apparatus may be of the same design, or they may be of a different design from one another. One or more of the vessels and/or conduits disclosed herein may include static mixing vanes positioned therein to further promote mixing and subsequent homogenization of the molten material.

Downstream glass manufacturing apparatus 30 may further include another conditioning chamber such as delivery vessel 40 located downstream from mixing apparatus 36. Delivery vessel 40 can act as an accumulator and/or flow controller to provide a consistent flow of molten glass 28 to forming body 42 by way of exit conduit 44. The molten glass within delivery vessel 40 can, in some embodiments, include a free surface, wherein a free volume extends upward from the free surface to a top of the delivery vessel. As shown, mixing apparatus 36 can be coupled to delivery vessel 40 by way of third connecting conduit 46 extending from a bottom of delivery vessel 40, wherein molten glass 28 can be gravity fed from mixing apparatus 36 to delivery vessel 40 through third connecting conduit 46.

Downstream glass manufacturing apparatus 30 may further include forming apparatus 48 configured to form a glass article, for example glass ribbons. Accordingly, forming apparatus 48 may comprise a down-draw apparatus, such as an overflow down-draw apparatus, wherein exit conduit 44 extending from delivery vessel 40 is positioned to deliver molten glass 28 from delivery vessel 40 to inlet conduit 50 of forming body 42. In embodiments, exit conduit 44 may extend into an open end of inlet conduit 50. For example, a diameter of a distal end of exit conduit 44 farthest from delivery vessel 40 may be less than a diameter of the open end of inlet conduit 50 such that the distal end of exit conduit 44 extends into and is concentric with inlet conduit 50, with a gap existing between the distal end of exit conduit 44 and the open end of inlet conduit 50. Molten glass in the gap between the distal end of exit conduit 44 and the open end of inlet conduit 50 may be exposed to the ambient atmosphere.

Forming body 42 in a fusion down-draw glass manufacturing apparatus can comprise a trough 52 positioned in an upper surface of the forming body and opposing converging forming surfaces 54 (only one surface shown) that converge in a draw direction 56 along a bottom edge (root) 58 of the forming body. Molten glass delivered to trough 52 via delivery vessel 40, exit conduit 44, and inlet conduit 50 overflows the walls of trough 52 and descends along converging forming surfaces 54 as separate flows of molten glass. The separate flows of molten glass join below and along the root 58 to produce a ribbon of molten glass that is drawn in draw direction 56 from root 58 by applying a downward tension to the molten glass ribbon, such as by gravity and opposing, counter-rotating pulling rolls. The applied downward tension, and the temperature of the molten glass, can be used to control dimensions of the glass ribbon as the molten glass cools and a viscosity of the molten glass increases. Accordingly, the molten glass ribbon goes through a viscosity transition, from a viscous state to a viscoelastic state to an elastic state and acquires mechanical properties that give glass ribbon 60 stable dimensional characteristics. Glass ribbon 60 may then be scored, then divided into shorter lengths, such as into glass sheets 62. Alternatively, glass ribbon 60 may be spooled. Glass ribbon scoring apparatus 64 may comprise a gantry (not shown) capable of vertical movement along the draw direction at the draw speed. Glass sheets may be removed from the glass ribbon by a robot 66. For example, robot 66 may bend the glass ribbon at the score, causing the glass ribbon to separate along the score and form glass sheet 62.

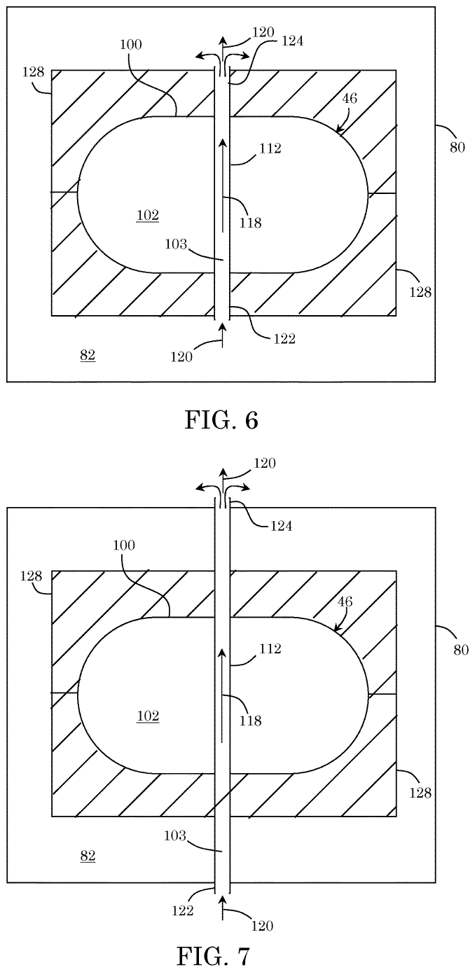

Components of downstream glass manufacturing apparatus 30, including any one or more of connecting conduits 32, 38, 46, fining vessel 34, mixing apparatus (e.g., stirring vessel) 36, delivery vessel 40, exit conduit 44, or inlet conduit 50 may be formed from a precious metal. Suitable precious metals include platinum group metals selected from the group consisting of platinum, iridium, rhodium, osmium, ruthenium, and palladium, or alloys thereof. For example, downstream components of the glass manufacturing apparatus may be formed from a platinum-rhodium alloy including from about 70% to about 90% by weight platinum and about 10% to about 30% by weight rhodium. Because such precious metals represent a significant expense, the various vessels (e.g., conduits) are formed with walls having a thickness no greater than necessary, and because they are also operated high temperatures, some of which may approach the softening temperature of the metal, the vessels may not be capable of supporting the weight of the molten glass contained therein at operating temperatures without assistance. Accordingly, refractory ceramic materials 68 (see FIGS. 6a, 6B) may be positioned around the vessels, refractory materials 68 functioning to both support the vessel, help maintain its structural integrity, and to regulate heat loss from the vessel. The refractory materials may be formed in blocks, sheets, or plates, poured into place around a vessel as a slurry and subsequently hardened (“e.g., “castable” refractory materials), or both. Refractory ceramic material 68 may be arranged in multiple layers, wherein different layers of refractory material have different thermal conductivities. In embodiments, different angular portions of the conduit (e.g., third conduit 46) may be encased in refractory materials of different thermal conductivities. For example, in some embodiments, a top of the conduit may be encased in one or more layers of refractory material, wherein the overall thermal conductivity (e.g., average thermal conductivity) of the refractory over the top portion of the conduit may be different than the overall thermal conductivity of the refractory material beneath the conduit or at the sides of the conduit. Similarly, the thermal conductivity of refractory material 128 may vary along a length of the conduit, such that one longitudinal portion of the conduit is configured to lose more heat that another portion of the conduit, either upstream or downstream (relative to a direction of flow of the molten glass within the conduit).

A common oxidation reaction that can occur at the metal-molten glass interface of metallic (e.g., precious metal) vessels used in the manufacture of glass is the conversion of negatively charged oxygen ions to molecular oxygen, which can be caused by the thermal breakdown of water and hydroxyl species in the molten glass. At the elevated temperatures of glass melting and delivery, a low partial pressure of hydrogen exists in the molten glass. When the molten glass contained in a precious metal vessel (e.g., conduit) comes in contact with the precious metal, hydrogen in the molten glass rapidly permeates through the vessel wall, depleting the molten glass proximate the metal-glass interface of hydrogen. For every mole of hydrogen that leaves the vessel, ½ mole of oxygen is left behind at the metal-glass interface. Thus, as hydrogen leaves the vessel, the oxygen level, e.g., the partial pressure of oxygen at the metal-glass interface, increases, which can lead to the generation of blisters (gaseous inclusions) in the molten glass.

To mitigate against gaseous inclusions, at least a portion of downstream glass manufacturing apparatus 30, which may include any one or more of vessels 34, 36, 40, and conduits 32, 38, 46, and 44, may be encapsulated or encased within an enclosure 80 designed to maintain a specific environment around the vessel. Enclosure 80 is a small enclosure that produces a small jacket volume 82 between the enclosed equipment and the enclosure that better facilitates control of the atmosphere within the enclosure 80. For example, compared to a large, room-sized enclosure. This is due to the fact that a sensor reading (such as relative humidity or dew point temperature) for conditions inside enclosure 80 is more likely to be representative of conditions at the exterior metal surfaces of glass processing equipment, since the volume in the enclosure 80 is smaller than the volume in an open factory floor space.

Jacket volume 82 of enclosure 80 is defined between the interior walls of enclosure 80 and the exterior surfaces of any one or more of vessels 34, 36, 40, and conduits 32, 38, 46, and 44 that may be contained in the enclosure. Enclosure 80 may be leak tight to the extent that it may be used for maintaining a slightly more positive pressure of low oxygen, moist atmosphere inside jacket volume 82 that is greater than ambient pressure conditions outside enclosure 80. As shown, enclosure 80 can be made as one zone that encloses the precious metal-containing components of downstream glass manufacturing apparatus 30. Alternatively, multiple enclosures 80 can be used to form multiple zones where individual enclosures 80 may separately enclose one or more of the vessels 34, 36, 40, and conduits 32, 38, 46, and 44. An advantage of utilizing multiple enclosures 80 is the ability to independently control the atmosphere in particular areas of downstream glass manufacturing apparatus 30.

Enclosure 80 may further include a closed-loop control system 84 configured to control the atmosphere within enclosure 80 and reduce or prevent oxidation reactions from occurring at the metal-glass interface inside vessels 34, 36, 40, and conduits 32, 38, 46, and 44 that may result in gaseous inclusions.

In particular, closed-loop control system 84 can control the atmosphere inside enclosure 80 (and outside the enclosed components) to suppress undesirable oxidation reactions at the metal-glass interface by causing the migration of hydrogen into the glass-metal interface. A controlled level of hydrogen permeation into the glass-metal interface reduces the production of undesirable species such as molecular oxygen, and halogens, which in turn may prevent the formation of undesirable gaseous inclusions in molten glass 28. Hydrogen permeation through the metal walls of the vessels and/or conduits can be achieved by supplying a higher partial pressure of hydrogen to the exterior surfaces (the non-glass contact surfaces) of metallic components of downstream glass manufacturing apparatus 30 relative to the partial pressure of hydrogen at the interior glass-metal interfaces. Accordingly, a humid, low oxygen atmosphere, which may result in a controlled level of hydrogen at the non-glass contact surfaces of platinum-containing components of the downstream glass manufacturing apparatus 30 may be maintained inside enclosure 80. Accordingly, closed-loop control system 84 may include an O₂ and/or N₂ makeup system 86 comprising an oxygen supply 88 and a nitrogen supply 90 (or supply of another inert gas like argon or helium). Closed-loop control system 84 may further comprise a source of water vapor 92 and an air source 94, for example as a carrier for the water vapor. The air and water vapor may be provided to enclosure 80 through an air handler 96.

The exemplary closed-loop control system 84 may include a controller that obtains sensor readings from one or more locations within and outside enclosure 80. The controller processes the sensor measurements and controls different devices, like air handler 96 and O₂ and/or N₂ makeup system 86. In operation, the controller controls the various devices to create an atmosphere inside enclosure 80 in which hydrogen generating water vapor decomposition occurs at a rate equal to or greater than the rate of hydrogen permeation through the metal walls of components 34, 36, 40, 32, 38, 46, and 44 that would be occurring if an ambient atmosphere were present at the non-glass contact surfaces of the components. When there is a higher partial pressure of hydrogen, the reduction of undesirable species such as molecular oxygen and/or halogens within molten glass 28 prevents the formation of undesirable gaseous inclusions in the molten glass. Another advantage of having a higher partial pressure of hydrogen is that the rate of oxidation of the platinum containing components 34, 36, 40, 32, 38, 46, and 44 may be reduced or possibly eliminated due to the low level of oxygen inside enclosure 80.

A goal of downstream glass manufacturing apparatus 30 is to produce and process molten glass and deliver the molten glass to forming apparatus 48 such that the molten glass may be formed into a glass product, for example glass sheet. Accordingly, molten glass provided from glass melting furnace 12 is processed in fining vessel 34 to remove gaseous inclusions, homogenized in mixing apparatus 36, and delivered to forming apparatus 48 (e.g., forming body 42) via delivery vessel 40. This further entails ensuring the molten glass is delivered to the forming apparatus at a temperature (i.e., viscosity) appropriate for forming. For example, the molten glass formed via a fusion downdraw process must have sufficient viscosity flowing from the root of the forming body as a ribbon to be supported by the edge portions of the ribbon. Conduits extending between the foregoing components (e.g., fining vessel 34, mixing apparatus 36, and delivery vessel 40) may be used to decrease the average temperature of the molten glass for downstream processing requirements. For example, second conduit 38 and third connecting conduit 46 may comprise cooling zones, wherein heating or cooling methods may be used to control the rate of heat loss from the conduit to achieve a predetermined molten glass viscosity at designated locations along the flow path. Such heating and/or cooling methods can include any one or more of external heating coils adjacent the conduit, direct heating of the conduit (wherein an electrical current is established in a wall of the conduit that heats the conduit by Joule heating, thereby regulating heat loss from the conduit), refractory thermal insulating material surrounding the conduit selected to have a predetermined thermal conductivity, and forced convection around the conduit using blower equipment. A single conduit may have a plurality of cooling zones such that the amount of heat lost by the conduit (and thus the molten glass flowing therethrough) varies at different locations within the conduit. For example, the molten glass may be cooled in second conduit 38 from fining temperatures, which are typically the hottest system temperatures and may be in excess of 1600 °C, to mixing temperatures, which typically correspond to a viscosity in a 1000-3000 Poise range. This cooling can provide a temperature reduction in a range from about 100 °C to about 300 °C. Third connecting conduit 46 may further cool the molten glass from mixing temperatures down to a delivery temperature and viscosity suitable for entry to the forming body, nominally a viscosity of about 35 kPoise or greater. This further cooling can provide additional temperature reduction in a range from about 100 °C to about 300 °C. To achieve such cooling rates, the precious metal conduits are typically sized to have sufficient surface area for maximum heat conduction (removal) through the outer refractory structure surrounding and supporting the conduit. The combination of geometry and thermal conductivity of the refractory materials, as well as the process environmental boundary conditions, dictate the magnitude of heat loss. As the flow of molten glass is increased to increase production, or to produce glass with high cooling gradient requirements based on viscosity points of the glass, an increase in heat loss provided by the conduits, e.g., second conduit 38 and/or third connecting conduit 46, can be accommodated by any combination of (1) additional precious metal conduit length or effective conduit diameter, (2) the use of greater thermal conductivity refractory materials supporting the conduit, and/or (3) an increase in forced convection cooling applied to an exterior of the refractory.

Nonetheless, this design and scaling approach has practical limits—the cost of horizontal footprint increase in a manufacturing facility and the additional precious metal capital cost for lengthened or increased-diameter conduits, the limits of known refractory material thermal conductivities, and negative effects of excessive forced convection cooling such as defect formation in the glass and risks to the material assets. In addition, these combinations cool from the wall of the conduit, which can create a large radial temperature gradient between the molten glass within a central region of the conduit and molten glass proximate the inside surface of the wall or walls of the conduit. Such thermal gradients can result in glass flow control challenges and require compensation in the forming process that may negatively impact product attributes. In more extreme cases, edges of the cooling zones may fall below the liquidus temperature, resulting in a devitrification risk to the molten glass, especially for lower liquidus viscosity and/or high crystal growth rate glass compositions. The liquidus temperature is the temperature above which a material is completely liquid and the maximum temperature at which crystals can coexist in the molten material in thermodynamic equilibrium. Accordingly, such temperature excursions can exacerbate the radial temperature gradient within the conduit and potentially result in solid inclusion defects affecting product yield. Doping glasses with infrared light (IR) absorbing species, such as Fe²⁺, will have an even greater radial effect due to heat transfer changes in the molten glass.

Cooling at greater viscosities in a glassmaking process without the ability for downstream chemical thermal equilibration (e.g., stirring, or sufficient time at sufficiently low viscosity) risks creating thermally generated artifacts in the resultant glass product due to the nature of the melt-to-glass transition, where viscosity rapidly increases, and local relaxation times vary. This can result in density variations in the glass product, which may manifest as a “streak” defect—a sustained localized and compositionally-driven density difference that may exist as the molten glass transitions to a solid ribbon and which may manifest as a visible defect in the ribbon. Similarly, if cooling is not carefully executed, devitrification can occur, which can result in solid inclusion defects in the glass, which may not redissolve, or simply alter the composition, which, if downstream of chemical homogenization (e.g., mixing) steps, can result in a streak defect.

Accordingly, apparatus and methods are described that employ cooling directed to the hotter central region of molten glass flowing within a conduit. Such cooling methods can alter historical scaling practices to achieve higher glass flow rates per unit of precious metal without significant changes to cooling fluid (e.g., gas) flow rates. Additionally, because the cooling is directed to the central interior region of the conduit, these methods may directionally counter the radial thermal gradient effect, resulting in higher peripheral temperatures for the molten glass and reducing devitrification risks.

Apparatus and methods described herein may reduce precious metal use (e.g., platinum group metals) through redesign of the molten glass downstream apparatus to achieve similar flow (improved return on capital) or be used to increase molten glass flow to reduce unit cost, or both. Mitigation of radial temperature gradient effects may improve unit cost through improved yields by increasing the ability to provide products having strong IR absorbers (e.g., Fe²⁺ doped glasses) with higher glass flow per capital asset. By way of example and not limitation, aspects of the present disclosure will be discussed in respect of third connecting conduit 46, with the understanding that these aspects may be applied in respect of other vessels and/or conduits of the disclosure, including second conduit 38.

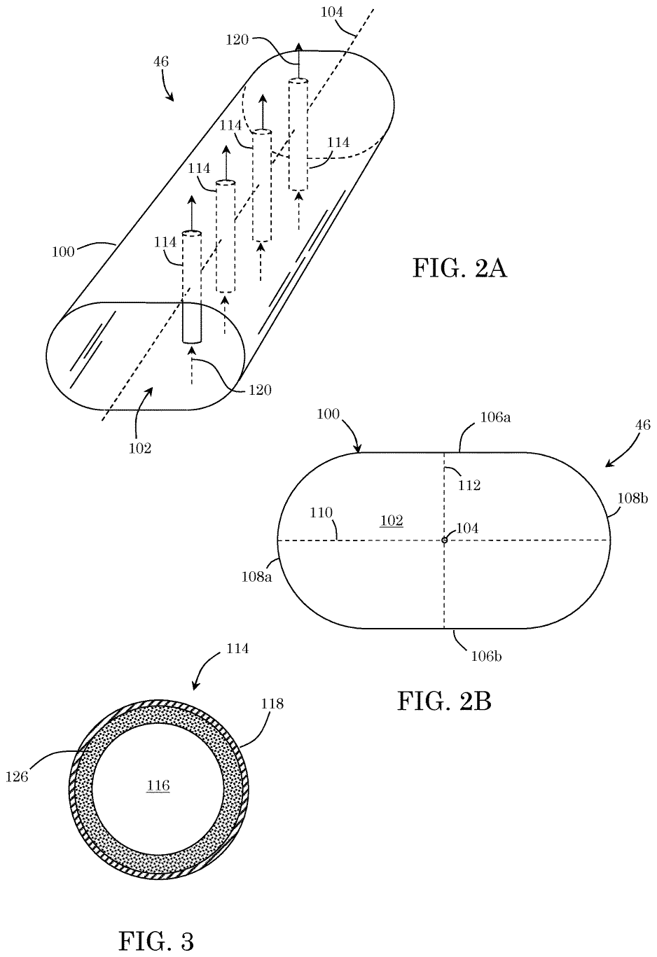

As shown in FIGS. 2A and 2B, third connecting conduit 46 comprises a wall 100 forming a periphery of the conduit, wall 100 extending around and defining an interior passage 102 of third connecting conduit 46 configured to receive a flow of molten glass therethrough. Third connecting conduit 46 further comprises a longitudinal axis 104 centrally positioned within and extending through at least a portion of third connecting conduit 46. That is, third connecting conduit 46 need not be linear along its entire length. FIGS. 2A and 2B depict third connecting conduit 46 as having a combination of oval (or circular) and straight profiles in cross-section in a plane orthogonal to longitudinal axis 104. For example, third connecting conduit 46 may comprise a wall including opposing circular or oval arcs joined by opposing straight wall sections, so the conduit appears as a flattened oval or flattened circular shape when viewed in cross-section. However, third connecting conduit 46 is not limited to a flattened oval or flattened circular cross-sectional shape. For example, third connecting conduit 46 may have a circular cross-sectional shape, an oval cross-sectional shape, a rectangular (e.g., square) cross-sectional shape, or any other cross-sectional shape suitable for conveying molten glass through interior passage 102.

In the embodiment depicted in FIGS. 2A and 2B, third connecting conduit 46 comprises a first, upper wall section 106a, a second, lower wall section 106b opposing first wall section 106b, and wherein the first and second wall sections 106a, 106b are joined at their ends by two opposing arcuate wall sections (oval or circular arcs), first arcuate wall section 108a and second arcuate wall section 108b. First and second wall sections 106a, 106b, viewed in cross-section (see FIG. 2B), may be substantially flat (shown as straight lines in cross-section). First and second arcuate wall sections 108a, 108b may comprise circular arcs, oval arcs, or any other convexly curved shape (convex relative to central longitudinal axis 104). Accordingly, third connecting conduit 46 may further comprise a major axis 110 and a minor axis 112 orthogonal to major axis 110, wherein major axis 110 represents a maximum diameter of third connecting conduit 46 and minor axis 112 represents a minimum diameter of third connecting conduit 46. Each of major axis 110 and minor axis 112 are orthogonal to longitudinal axis 104. Longitudinal axis 104 may intersect the intersection of major axis 110 and minor axis 112.

Referring again to FIG. 2A, third connecting conduit 46 further comprises one or more cooling tubes 114 extending within interior passage 102 and through the central region of the interior passage. The one or more cooling tubes 114 each define a passage 116 extending through the cooling tube that is separated from interior passage 102 of third connecting conduit 46 by wall 118 of the cooling tube. The one or more cooling tubes 114 may extend orthogonal to longitudinal axis 104. In embodiments, the one or more cooling tubes may intersect longitudinal axis 104. For example, each cooling tube 114 may extend across a diameter of third connecting conduit 46, for example along minor axis 112. In some embodiments, the one or more cooling tubes 114 may extend at a non-zero but non-orthogonal angle relative to longitudinal axis 104, for example along major axis 110.

Molten glass may flow through interior passage 102 of third connecting conduit 46 and a cooling fluid 120 (e.g., gas) may flow through a cooling passage 103 defined by the one or more cooling tubes 114 while a separation is maintained between molten glass 28 and cooling fluid 120 by the cooling tube wall 118. Cooling fluid 120 may comprise air. However, in further embodiments, cooling fluid 120 may comprise predominately monatomic noble gas or gases (e.g., argon, krypton, and/or helium). In some embodiments, cooling fluid 120 may be predominantly a diatomic gas, for example an inert gas such as nitrogen. Cooling fluid 120 may comprise both noble and inert gases. Cooling fluid 120 may include hydrogen. Cooling fluid 120 may comprise equal to or greater than 50% by volume noble and/or inert gas. In embodiments, the cooling fluid 120 may comprise equal to or less than about 21% by volume oxygen, equal to or less than about 15% oxygen, equal to or less than about 10% by volume oxygen, equal to or less than about 5% by volume oxygen, or equal to or less than about 1% by volume oxygen. By limiting the amount of oxygen in the cooling fluid, oxidation of the cooling tube can be minimized. However, cooling fluid is not limited to gas. In some embodiments, cooling fluid 120 may be a liquid, such as water or other suitable liquid cooling medium.

Each cooling tube 114 comprises a first end 122 and a second end 124 opposing first end 122 (see FIGS. 6, 7). In embodiments, cooling tube wall 118 may be formed from the same material as the connecting conduit to which the cooling tube is joined, e.g., third connecting conduit 46. For example, third connecting conduit 46 may comprise platinum, e.g., a platinum-rhodium alloy. In such instances, cooling tubes 114 may similarly comprise platinum, such as the same or similar platinum-rhodium alloy. Referring to FIG. 3, in embodiments, each cooling tube 114 may be lined with an inorganic refractory lining 126, for example an alumina or zirconia refractory lining. Refractory lining 126 can avoid large temperature reductions of molten glass 28 which would otherwise be in direct contact with the interior surface of cooling tube wall 118. The presence of refractory lining 126 can avoid temperature reductions in the molten glass that might result in the temperature of the molten glass dropping below the liquidus temperature of the molten glass, thereby avoiding devitrification and/or compositional streak generation. Cooling fluid flow rates and refractory liner thickness and material combinations can be selected such that internal cooling tube wall temperatures do not fall below the liquidus temperature of the molten glass composition, thereby avoiding devitrification defects or the potential for compositional streak defects.

In accordance with some aspects, cooling fluid 120 may comprise the atmosphere within jacket volume 82. That is, first and second ends 122, 124 may be open to jacket volume 82 such that the atmosphere in jacket volume 82 is free to flow through the one or more cooling tubes. This flow may be driven by thermodynamics, wherein the internal atmosphere within jacket volume 82, heated by third connecting conduit 46 and the molten glass flowing therein, rises upward through the one or more cooling tubes 114. Moreover, flow may be further driven by air handler 96.

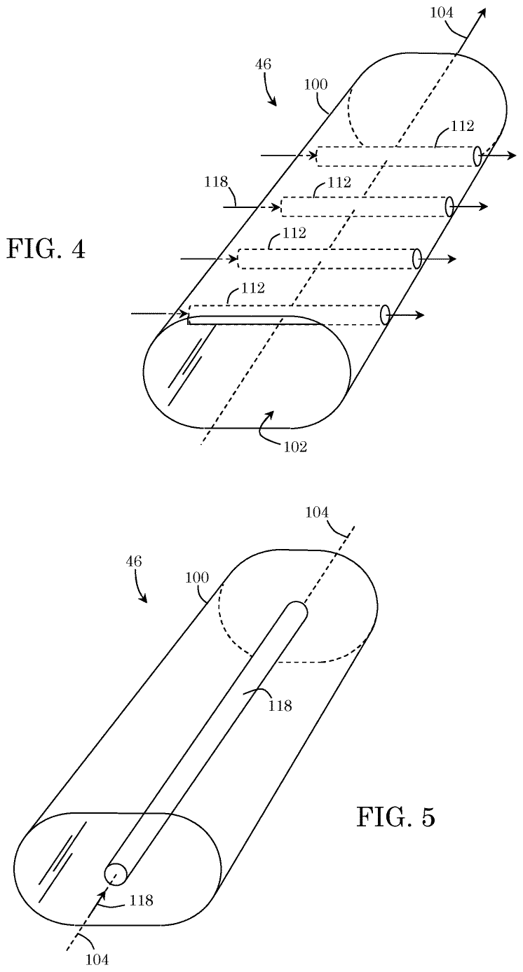

Cooling tubes 114 may be oriented at any radial angle, for example any radial angle in a plane orthogonal to longitudinal axis 104. For example, cooling tubes 114 may extend orthogonally to first and second wall sections 106a, 106b, as shown in FIG. 2A, horizontally as shown in FIG. 4, or any angle therebetween. Additionally, cooling tubes 114 may be angled either in a direction of the flow of molten glass through third connecting conduit 46, or against the flow of molten glass in third connecting conduit 46. Put another way, the at least one cooling tube 114 may not be orthogonal to longitudinal axis 104, but instead form an angle with longitudinal axis 104, for example an acute angle. As shown in FIG. 5, in some embodiments, at least a portion of the at least one cooling tube 114 may be parallel with longitudinal axis 104, e.g., extend along longitudinal axis 104 within third connecting conduit 46.

In embodiments, the at least one cooling tube 114 may extend beyond wall 100 of third connecting conduit 46. For example, as illustrated in FIG. 6, the one or more cooling tubes 114 may extend through the thickness of the one or more layers of refractory material 128 such that first and second ends 122, 124 of cooling tubes 114 open into jacket volume 82 between refractory material 128 and enclosure 80. For example, in some embodiments, one or both ends 122, 124 may extend into jacket volume 82. Referring to FIG. 7, in other embodiments, the one or more cooling tubes 114 may extend through refractory material 128, jacket volume 82, and enclosure 80. In such embodiments, cooling fluid 120 may be supplied to the at least one cooling tube 114 via a cooling gas supply external to enclosure 80. The cooling fluid may be supplied, for example, as a “house” gas stored under pressure in on-site containers (e.g., gas cylinders, not shown) and available to the at least one cooling tube 114, and/or other on-site apparatus, through suitable coolant piping (not shown). In further embodiments, cooling fluid 120 may be pumped through the one or more cooling tubes 114. In embodiments, a plurality of cooling tubes may be interconnected by a common plenum used to supply the cooling tubes with cooling fluid 120.

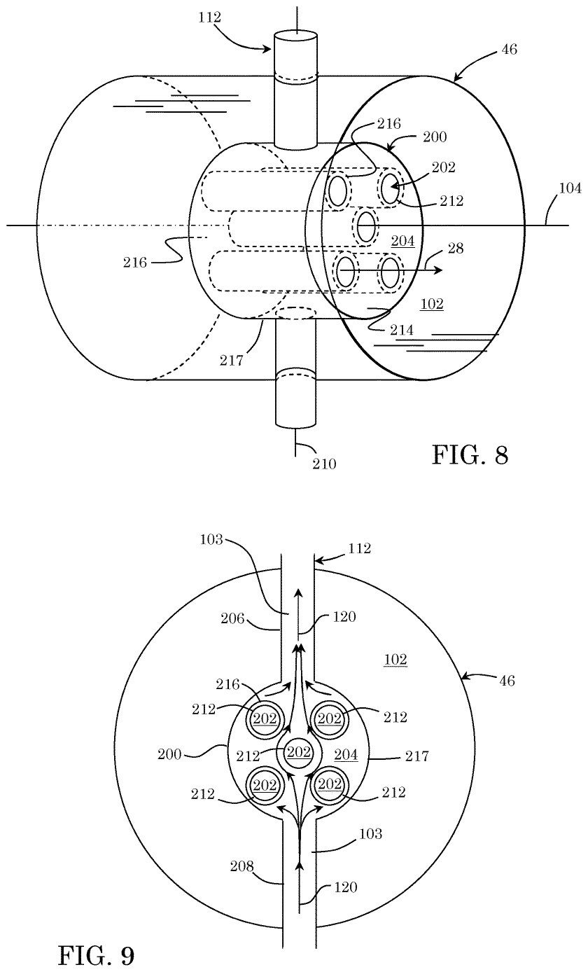

In some embodiments, the at least one cooling tube 114 may comprise a cooling chamber, the cooling chamber configured to add additional surface area to the cooling tube and increase heat extraction from molten glass flowing through connecting conduit 46, and in particular the central region of interior passage 102. FIGS. 8-9 depict a perspective view and a cross-sectional view, respectively, of a portion of a connecting conduit 46. In this embodiments, third connecting conduit 46 is shown having a circular cross-sectional shape in a plane orthogonal to longitudinal axis 104, but may have a different cross-sectional shape, for example a cross-sectional shape as shown in FIGS. 6 and 7, or any other suitable cross-sectional shape. Refractory material 68 may be present but is not shown. In the embodiments of FIGS. 8-9, a cooling tube 114 comprises a cooling chamber 200 positioned within conduit interior passage 102, cooling chamber 200 comprising a plurality of flow-through passages 202 through which molten glass 28 flows as the molten glass flows through interior passage 102 of third connecting conduit 46. That is, at least a portion of a flow path of molten glass through third connecting conduit 46 extends through flow-through passages 202 in cooling chamber 200. Cooling chamber 200 is shown as a hollow cylinder in FIGS. 8-9 defining an internal volume 204 in fluid communication with cooling passage 103 of cooling tube 114 such that cooling fluid 120 flowing through cooling tube 114 flows also through cooling chamber 200. Shapes other than cylindrical shapes may be employed for cooling chamber 200. Generally, a lateral dimension of cooling chamber 200 will be greater than a similar lateral dimension of other portions of cooling tube 114. For example, as shown by the embodiments depicted in FIG. 9, a diameter of an upper portion 206 of cooling tube 114 above cooling chamber 200, and/or a diameter of a lower portion 208 of cooling tube 114 below cooling chamber 200, is less than a diameter of cooling chamber 200. In terms of area, a cross-sectional area of upper portion 206 of cooling tube 114 and/or a cross-sectional area of lower portion 208 may be less than a cross sectional area (for example a maximum cross-sectional area) of cooling chamber 200, each cross-sectional area defined by a boundary (wall) of the respective portion of the cooling tube in a respective plane parallel with longitudinal axis 104 (e.g., orthogonal to longitudinal axis 210 extending through cooling tube 114). Flow-through passages 202 are defined by interior surfaces of cross-tubes 212 extending across and positioned within cooling chamber 200, such that flow-through passages 202 represent interior passages of the cross-tubes 212. Accordingly, exterior surfaces of cross-tubes 212 are interior surfaces of cooling chamber 200.

In some embodiments, cooling chamber 200 may be cylindrical and comprise a first cooling chamber wall 214 and a second cooling chamber wall 216 opposite first cooling chamber wall 214, wherein first cooling chamber wall 214 and second cooling chamber wall 216 are parallel chamber walls, for example planar parallel walls. However, in further embodiments, first cooling chamber wall 214 and second cooling chamber wall 216 may be curved chamber walls. First cooling chamber wall 214 and second cooling chamber wall 216 are joined by a cylindrical cooling clamber wall 217. In the embodiment depicted in FIGS. 8-9, cross-tubes 212 are arranged parallel to longitudinal axis 104 and extend between first and second cooling chamber walls 214, 216, which provides the least resistance to flow of molten glass through flow-through passages 202. However, other orientations of cross-tubes 212 are contemplated.

In embodiments, cooling fluid 120 flows through cooling tube 114, including cooling chamber 200, and contacts an exterior surface of cross-tubes 212 in contact with the cooling fluid 120 (as well as the interior surfaces of cooling tube 114 and including cooling chamber 200). Meanwhile, at least a portion of molten glass 28 flowing through third connecting conduit 46 flows through flow-through passages 202 formed by cross-tubes 212. Heat exchange between the molten glass flowing through interior passages of the cross-tubes (i.e., flow-through passages 202) and cooling fluid 120 flowing through cooling tube 114, cooling chamber 200, and in contact with the exterior surfaces of cross-tubes 212, extracts heat from the molten glass in contact with cross-tubes 212, thereby cooling the molten glass. Placement of cooling chamber 200 in a central region of third connecting conduit 46 cools the central portion of the flow of molten glass through the conduit, further reducing radial temperature gradients in the molten glass flow. While not shown, an interior surface of cooling chamber 200 may be provided with a refractory material as described for interior surfaces of other portions of cooling tube 114. In embodiments, exterior surfaces of cross-tubes 212 may be provided with a refractory ceramic material 218. Refractory ceramic material 218 may be the same as refractory lining 126. The refractory materials may aid in moderating the cooling effect of the cooling chamber and preventing devitrification of the molten glass flowing through the third connecting conduit.

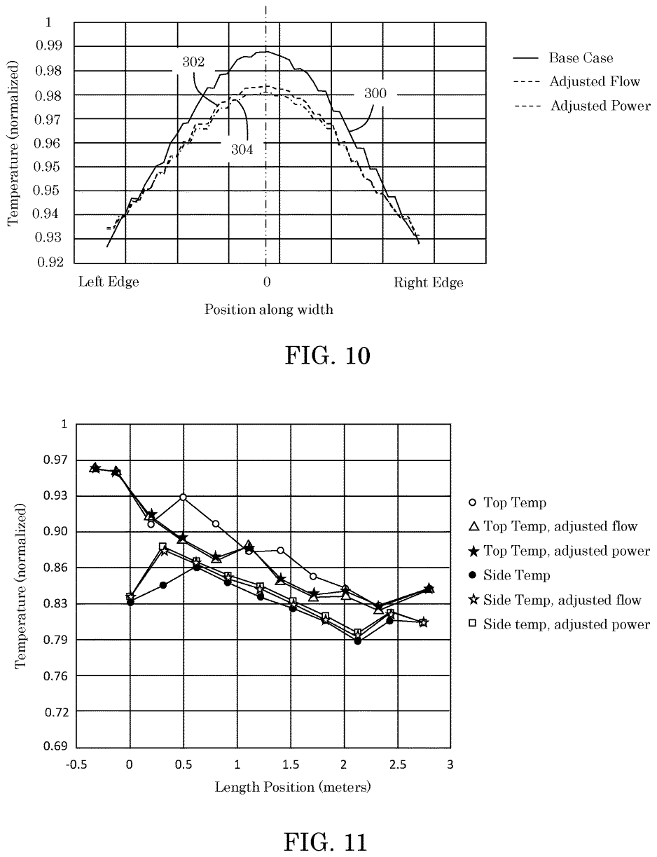

FIG. 10 is a graph showing modeled data for an exemplary direct heated third connecting conduit 46 extending between a mixing apparatus 36 and a delivery vessel 40 and comprising a plurality of cooling tubes under predetermined flow characteristics. The horizontal axis represents distance along a width of the conduit, and zero represents the center of the conduit. Temperature on the vertical axis is normalized. The solid curve 300 represents temperature as a function of position across a width of the conduit intersecting the longitudinal axis of the conduit for a base case (e.g., along major axis 110), i.e., without cooling tube cooling. The data show the radial temperature gradient that exists across the width of the molten glass flow, from the left edge of the flow of molten glass (at the left metal-molten glass interface) to the right edge of the flow of molten glass (at the right metal-molten glass interface). The dashed curve 302 represents the same arrangement, but with flow rate adjusted to obtain the same average exit temperature as the base case. The dashed and dotted curve 304 represents similar conditions as those for dashed curve 302, but with electrical power delivered to the direct heated conduit to again obtain the same average exit temperature at the outlet of the conduit. While the radial temperature gradient is apparent in all three curves, the curves including internal cooling via cooling tubes 114 (dashed curve 302 and dashed and dotted curve 304) show reduced central temperature (at position zero) compared to curve 300, for the same average exit temperature and the same or similar edge temperatures (temperature at the glass contact surface of sides of the conduit), and thus a reduced radial temperature gradient.

FIG. 11 is a graph showing (normalized) temperature as a function of length along the conduit of FIG. 10. The data show temperature at thermocouple locations along the edges of the flow of molten glass at the lateral sides of the conduit (at the metal-molten glass interface) and at the metal-molten glass interfaces at the top of the conduit. As in FIG. 10, data for adjusted flow and adjusted electrical power are shown in FIG. 11. Due to scale, temperature at the side edges of the molten glass flow appear only slightly higher in the adjusted flow case, while temperature at the top surfaces are generally significantly lower, indicating a reduced radial thermal gradient effect.

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

1. A glass manufacturing apparatus, comprising:
a first molten glass processing vessel;
a second molten glass processing vessel; and
a conduit extending between the first molten glass processing vessel and the second molten glass processing vessel, the conduit defining an interior passage extending therethrough configured to convey molten glass between the first molten glass processing vessel and the second molten glass processing vessel, the conduit comprising at least one cooling tube extending through the interior passage of the conduit, the at least one cooling tube defining a cooling passage isolated from the interior passage of the conduit by a wall of the cooling tube.

2. The glass manufacturing apparatus of claim 1, wherein the cooling tube comprises a ceramic refractory lining arranged within the cooling passage.

3. The glass manufacturing apparatus of claim 1, wherein the wall of the cooling tube comprises platinum.

4. The glass manufacturing apparatus of claim 3, wherein the wall of the cooling tube comprises a platinum-rhodium alloy.

5. The glass manufacturing apparatus of claim 1, wherein the conduit is surrounded by a ceramic refractory material, the cooling tube extending outward from the conduit through the ceramic refractory material.

6. The glass manufacturing apparatus of claim 5, wherein the conduit and the ceramic refractory material are arranged in an enclosure and ends of the cooling tube are in fluid communication with an atmosphere in the enclosure.

7. The glass manufacturing apparatus of claim 5, wherein the conduit and the ceramic refractory material are arranged in an enclosure and the cooling tube extends through the ceramic refractory material and a wall of the enclosure.

8. The glass manufacturing apparatus of claim 1, wherein the conduit comprises a central longitudinal axis, and a longitudinal axis of the cooling tube extends orthogonal to the central longitudinal axis of the conduit.

9. The glass manufacturing apparatus of claim 1, wherein the cooling tube comprises a plurality of cooling tubes.

10. The glass manufacturing apparatus of claim 9, wherein the plurality of cooling tubes are spaced apart and arranged linearly along a longitudinal axis of the conduit.

11. The glass manufacturing apparatus of claim 1, wherein the first molten glass processing vessel comprises a fining vessel and the second molten glass processing vessel comprises a mixing apparatus.

12. The glass manufacturing apparatus of claim 1, wherein the first molten glass processing vessel comprises a mixing apparatus and the second molten glass processing vessel comprises a delivery vessel comprising an exit conduit extending from a bottom of the delivery vessel.

13. The glass manufacturing apparatus of claim 1, wherein the cooling tube comprises a cooling chamber positioned within the conduit, the cooling chamber comprising a plurality of pass-through passages defined by interior surfaces of a plurality of cross-tubes extending through the cooling chamber, the flow-through passages configured to allow at least a portion of the molten glass conveyed through the conduit to flow through the flow-through passages.

14. The glass manufacturing apparatus of claim 13, wherein exterior surfaces of the plurality of cross-tubes are coated with a refractory ceramic material.

15. A method of manufacturing a molten glass article, comprising:
flowing molten glass from a first molten glass processing vessel to a second molten glass processing vessel through an interior passage defined by a conduit extending between the first molten glass processing vessel and the second molten glass processing vessel; and
cooling the molten glass in the conduit by flowing a cooling fluid through a cooling passage of a cooling tube extending through the interior passage.

16. The method of claim 15, wherein the cooling fluid comprises an inert gas.

17. The method of claim 15, further comprising cooling the cooling fluid prior to flowing the cooling fluid through the cooling passage.

18. The method of claim 15, wherein the cooling tube comprises a refractory ceramic lining arranged within the cooling passage.

19. The method of claim 15, wherein the cooling tube comprises a cooling chamber positioned within the conduit, the cooling chamber comprising a plurality of cross tubes extending through the cooling chamber, interior surfaces of the plurality of cross-tubes defining flow-through passages, the method further comprising flowing at least a portion of the molten glass flowing through the interior passage of the conduit through the flow-through passages.

20. The method of claim 15, wherein the cooling tube comprises a plurality of cooling tubes.
